(19) United States
(12) Patent Application Publication
(10) Pub. No.: US 2007/0296121 A1
(43) Pub. Date: Dec. 27, 2007

(54) Molding-system drive

(75) Inventor: Christopher Wai-Ming Choi, Richmond Hill (CA)

Correspondence Address: HUSKY INJECTION MOLDING SYSTEMS, LTD;CO/AMC INTELLECTUAL PROPERTY GRP, 500 QUEEN ST. SOUTH, BOLTON, ON, L7E 5S5, US

(73) Assignee: Husky Injection Molding Systems Ltd.

(21) Appl. No.: 11/448,262

(22) Filed: Jun. 7, 2006

(51) Int. Cl. B29C 45/00

(52) U.S. Cl. 264/328.11; 425/587; 425/162

(57) ABSTRACT

Disclosed are: (i) a molding-system drive, and (ii) a molding system having a molding-system drive, amougst other things.

### TECHNICAL FIELD

The present invention generally relates to, but is not limited to, molding systems, and more specifically the present invention relates to, but is not limited to, (i) a molding-system drive and (ii) a molding system having a molding-system drive, amongst other things.

### BACKGROUND

U.S. Pat. No. 4,929,165 (Inventor: Inaba et al; Published: 1990-05-29) discloses a straight-acting mold clamping system that selectively drives a movable platen by a fine- or a coarse-movement drive motor.

U.S. Pat. No. 5,540,495 (Inventor: Pickel; Published: 1996-07-30) discloses an injection unit for an injection-molding machine that has two hollow shaft electric motors, one for rotation, one for axial movement of a screw, and the motors are arranged disc fashion one behind the other.

U.S. Pat. No. 5,645,873 (Inventor: Carter; Published: 1997-07-08) discloses an extrusion-blow molding machine with electrically driven programming and purging actuators whose reliability and performance equals hydraulic actuators and are cleaner and more energy efficient.

U.S. Pat. No. 6,142,760 (Inventor: Niizeki et al; Published: 2000-11-07) discloses an actuation-control system for servomotors in an injection-molding machine, which includes a torque-calculation unit to synchronize a slave motor with a master motor.

U.S. Pat. No. 6,517,337 (Inventor: Hehl; Published: 2003-02-11) discloses a pressure injection molding machine that includes diverse modular drive assemblies to permit rapid connection of e.g. electromagnetic drives avoiding use of special adapters.

United States Patent Application Number 2003/0185091A1 (Inventor: Koike et al; Published: 2003-10-02) discloses a voice coil-type linear motor for use as a drive source for an electric injection molding machine that includes a cooling device for the coil.

United States Patent Application Number 2003/0209824A1 (Inventor: Koike et al; Published: 2003-11-13) discloses an injection unit of an injection-molding machine used in injection operations that has a direct-current linear motor and a screw installed in heating barrel.

U.S. Pat. No. 6,682,338 (Inventor: Maurilio; Published: 2004-01-27) discloses an injection assembly for an injection-molding machine, which has independent motors for sliding a movable plate by means of lead screws, nuts and external gear and a rotating plasticization screw, respectively.

United States Patent Application Number 2004/0013764A1 (Inventor: Dantlgraber; Published: 2004-01-22) discloses a drive system for straight line movement of a plastics injection unit to a tool and screw movement for injecting plastic. The drive system includes a motor driving a threaded spindle between clutch couplings for producing each movement.

United States Patent Application Number 2004/0018270A1 (Inventor: Becker et al; Published: 2004-01-29) discloses an injection unit for a plastics injection-molding machine that has a screw-rotating motor inside a linear motor with a stator connected to axially-moving secondary parts of the linear motor.

United States Patent Application Number 2004/0026809A1 (Inventor: Kuzumi et al; Published: 2004-02-12) discloses an injection device for injection molding, and the device in includes an injection member disposed in a cylinder member.

United States patent Application Number 2004/0071810A1 (Inventor: Hsu et al; Published: 2004-04-15) discloses an electromagnetic coaxial injector for an injection-molding machine, which has a linear motor to give a screw rod a longitudinal movement and a dosing unit to give it a defined rotation.

U.S. Pat. No. 6,769,892 (Inventor: Hehl; Published: 2004-08-03) discloses an injection molding machine with a cylindrical electric linear motor drive that involves several concentric nested stator and moving part pairs.

U.S. Pat. No. 6,793,477 (Inventor: Yoshioka; Published: 2004-09-21) discloses an injection mechanism for an injection molding machine that includes a linear motor having a movable section, an outer frame, and a fixed section.

U.S. Pat. No. 6,821,105 (Inventor: Fischbach; Published: 2004-11-23) discloses a closure and a clamping system for an injection molding machine that has a linear motor connected to a load transfer member and to a moving platen via levers.

U.S. Pat. No. 6,821,103 (Inventor: Tokuyama; Published: 2004-11-23) discloses an injection-molding machine that includes a voice-coil linear motor connected to tail end of screw and axially driving screw in heating barrel.

United States Patent Application Number 2005/0258795A1 (Inventor: Choi; Published: 2005-11-24) discloses an injection-molding machine energy-management control apparatus that includes a machine controller configured to communicate with electrically-driven prime movers, a common direct current link and a slave axis.

United States patent Application Number 2005/0048162A1 (Inventor: Teng at al; published 2005-03-03) discloses an injection unit for an injection-molding machine that has a hollow-electric motor and an hydraulic cylinder with cylinder walls, a piston, a rotator for piston, a mechanism for providing hydraulic fluid and a mechanism for attaching an injection screw to the piston.

Plasticization is a critical process, from amongst many processes, of an injection-molding system, and is also a large, if not the largest, consumer of power in most molding applications. A substantial amount of power is usually required by an injection unit (also called an extruder unit or a plasticization unit, etc) to process a molding material from a solid state to a plasticized state. Cycle time of a molding system, and in particular for an injection-molding system, is highly dependent on plasticization throughput of the injection unit. Reduction of cycle time of the molding system may be realized by: (i) reduce plasticization time, and/or (ii) increase injection speed. To address reduction of cycle time, a plasticization drive of the injection unit should ideally have: (i) higher power, (ii) higher torque, (iii) higher speed, and/or (iv) higher torque with higher speed. A preferred way of implementing a drive for driving the injection unit is to use a hollow-shaft, high-torque electric motor, which provides the following desirable attributes: (i) reduced noise, (ii) improved energy efficiency, (iii) reduced rotational inertia which results in a more dynamic, highly-responsive drive. Conventionally, each motor (drive) is controlled and powered by a drive-power (controller) unit which includes, at least but not limited to, a DC power supply, and an inverter having fast switching-power electronics. Unfortunately, the range and number of available (standard or off-the-shelf) models of hollow-shaft electric motors (drive) and corresponding controller units are very limited because electric-motor vendors and/or controller-unit vendors do not typically manufacture this type of electric motor (and controller unit) as mainstream, standard (off-the-shelf) products. If the desired performance requirements of the injection unit demand a hollow-shaft electric motor having a large torque output, custom-made (non-standard) motors would have to be constructed, and unfortunately this approach would likely lead to higher costs and longer deliveries from the electric-motor vendor. Since a required hollow-shaft motor must be sized to account for: (i) transient performances of acceleration and deceleration of the injection unit, and/or (ii) continuous performances of the injection unit, the required hollow-shaft electric motor will likely be larger (that is, different) than those motors that are available as standard, off-the-shelf products.

Despite the large number of vendors and offerings available for these components (drives, controllers), molding-machine designers are often challenged to find the exact motor or drive that will fit their requirements. This difficulty arises mainly from the fact that for many applications, no commercial off-the shelf (COTS) product provides an optimal combination of performance, price, packaging and life cycle persistence. As a result, system designers often: (i) make compromises in their choice of the components or (ii) work with vendors to develop unique offerings. As a result, lean manufacturing with reduced inventory and manufacturing costs and agile response to customers' needs (along with short product lead-time) are difficult to achieve. The current, unfortunate dilemma presents a serious problem for using electric motors in molding systems, and as of yet there appears to be no viable solution.

### SUMMARY

According to a first aspect of the present invention, there is provided a molding-system drive, including at least two in-line stators.

According to a second aspect of the present invention, there is provided a molding system, including at least two in-line stators.

According to a third aspect of the present invention, there is provided a method, including placing at least two stators of a molding-system drive in-line with each other, and placing at least two rotors of the molding-system drive in-line with each other, the at least two rotors cooperative with the at least two stators.

According to a fourth aspect of the present invention, there is provided a molding-system drive, including at least two in-line rotors.

According to a fifth aspect of the present invention, there is provided a molding system, including at least two in-line stators.

A technical effect, amongst other technical effects, of the aspects of the present invention is that since the molding-system drive includes multiple stators or multiple rotors, a manufacturer of a molding system is able to use stators and rotors that are available off the shelf from a variety of electric-motor vendors, and this permits cost reduction in (i) the molding-system drive, and (ii) the molding system that uses the molding-system drive.

### BRIEF DESCRIPTION OF THE DRAWINGS

A better understanding of the exemplary embodiments of the present invention (including alternatives and/or variations thereof) may be obtained with reference to the detailed description of the exemplary embodiments along with the following drawings, in which:

FIG. 1 is an exploded-perspective view of a molding-system drive according to a first exemplary embodiment (which is the preferred embodiment);

FIG. 2 is another exploded-perspective view of the molding-system drive of FIG. 1; and

FIG. 3 is yet another exploded perspective view of the molding system drive 100 of FIG. 1.

The drawings are not necessarily to scale and are sometimes illustrated by phantom lines, diagrammatic representations and fragmentary views. In certain instances, details that are not necessary for an understanding of the embodiments or that render other details difficult to perceive may have been omitted.

### DETAILED DESCRIPTION OF THE EXEMPLARY EMBODIMENTS

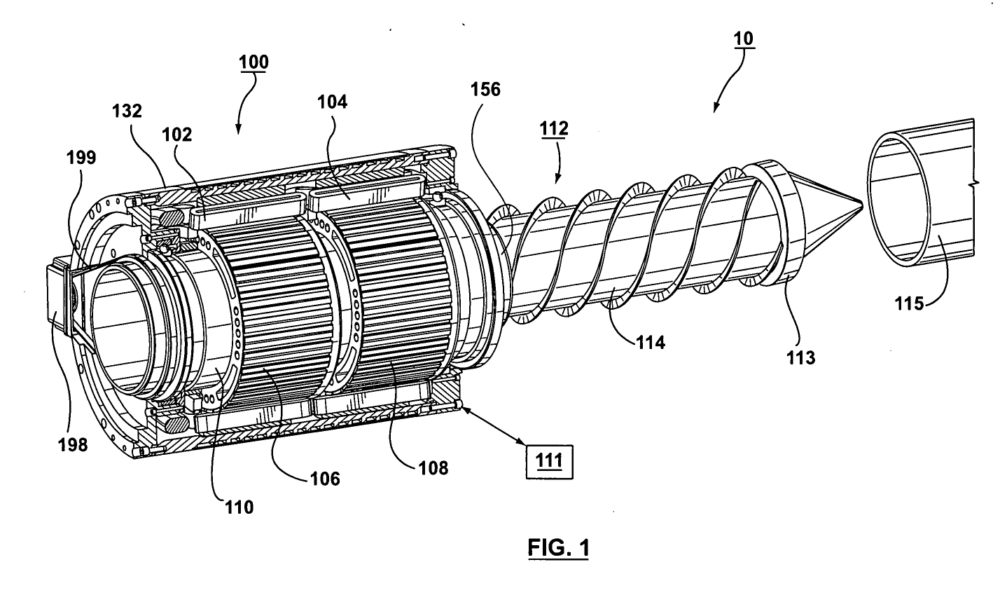

FIG. 1 is an exploded-perspective view of a molding-system drive 100 (hereafter referred to as “the drive 100”) according to the first exemplary embodiment. The drive 100 is usable in a molding system 10. Examples of the molding system 10 are: (i) the HyPET™ System, (ii) the Quadloc™ System, (iii) the Hylectric™ System, and (iv) the Magnesium Molding System, all manufactured by Husky Injection Molding Systems Limited (Location: Bolton, Ontario, Canada; WWW-URL: www.huskv.ca). The drive 100 includes at least two or more in-line stators 102, 104, and also includes at least two or more in-line rotors 106, 108. A technical effect, amongst other technical effects, of the drive 100 is that since the drive 100 includes multiple stators and rotors, a manufacturer of a molding system is able to use stators and rotors that are available off the shelf from a variety of electric-motor vendors, and this permits cost reduction in (i) the drive 100, and (ii) the molding system 10 that uses the drive 100. Other technical effects are discussed below.

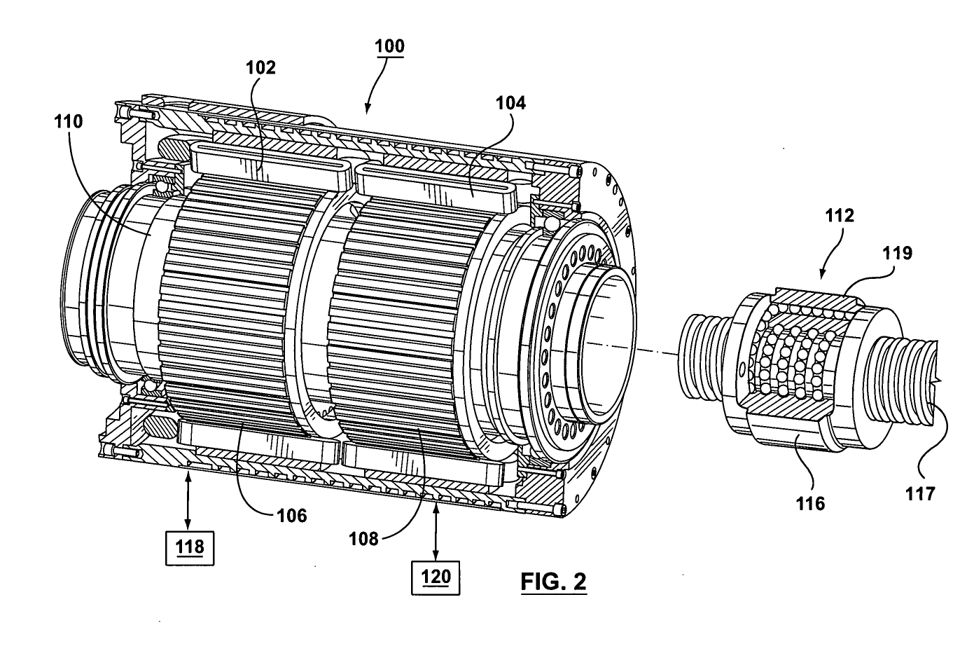

Preferably, the in-line rotors 106, 108 are mountable to a common shaft 110. The common shaft 110 may be a single shaft or multiple, connected shafts forming a longer shaft. According to a variant, the common shaft 110 includes a hollow shaft; according to another variant, the common shaft 110 includes a solid shaft. The common shaft 110 is connectable to a molding-system component 112, such as a processing screw 114. Attached to a distal end of the processing screw 114 is a check valve 113. The processing screw 114 is receivable in a barrel 115 of the molding system 10. The in-line stators 102, 104 and the in-line rotors 106, 108 are energizable to move (either rotate or translate) the molding-system component 112 via the common shaft 110. As depicted in FIG. 1, the connection of the common shaft 110 to the processing screw 114 enables rotational movement of the processing screw 112 (by way of using a spline 156). As depicted in FIG. 2, by operatively fixedly connecting or attaching: (i) the outer surface 119 (or hosuing) of a ball screw 116 to the common shaft 110 (that is, either to the edge of the shaft 110 or to the inner surface of the shaft 110), and (ii) a translatable shaft 117 of the ball screw 116 to the molding-system component 112, rotation of the common shaft 110 may be used to linearly translate the molding-system component 112. The manner of connecting the outer surface 119 and/or the shaft 117 is known to those skilled in the art.

Preferably, the in-line stators 102, 104 include a first stator 102, and a second stator 104 offset from the first stator 102 along the common shaft 110. The in-line rotors 106, 108 include a first rotor 106, and a second rotor 108 offset from the first rotor 106 along the common shaft 110. The in-line stators 102, 104 are operatively couplable to and controllable by a drive-controller 111. The in-line stators 102, 104 are mountable to a common housing 132. According to a variant (not depicted), stator 102 is mountable in a first housing (not depicted), while the stator 104 is mountable in a second housing (not depicted).

FIG. 2 is another exploded-perspective view of the drive 100 of FIG. 1. According to a variant, the first stator 102 is operatively couplable to and controllable by a first drive-controller 118, while the second stator 104 is operatively couplable to and controllable by a second drive-controller 120. An example of the drive-controllers 111, 118, 120 is described in United States Patent Application Number 2005/0258795A1. According to a variant, the molding-system component 112 includes the ball screw 116 that is attachable to the shaft 110. The ball screw 116 enables the drive 100 to linearly translate the molding system component 112, and preferably the spline 156 is not used in this variant.

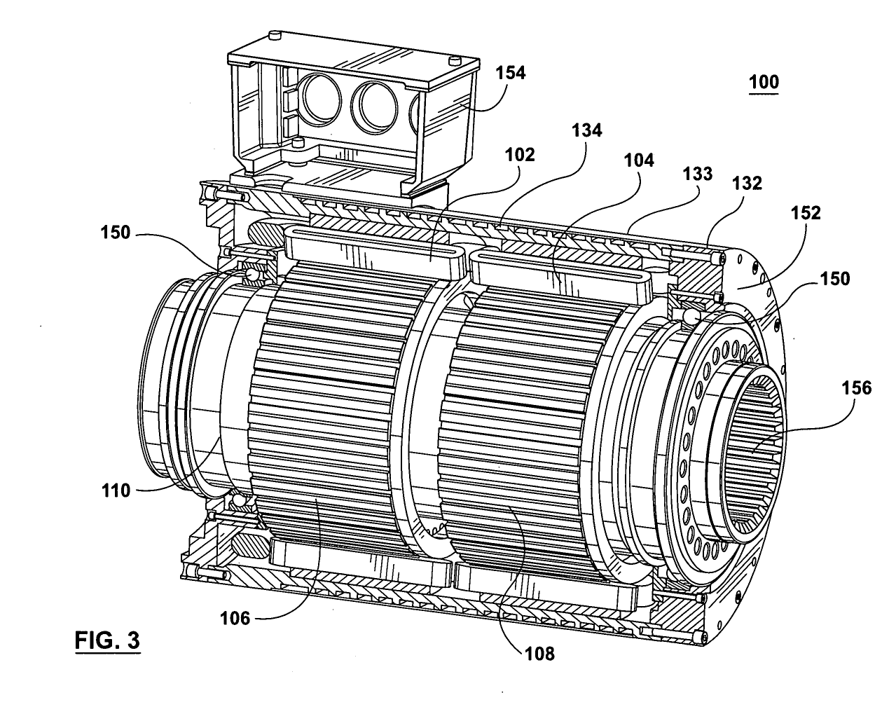

FIG. 3 is yet another exploded-perspective view of the drive 100 of FIG. 1. Preferably, the rotors 106, 108 include magnets, and the stators 102, 104 include windings. Dowels (not depicted) may be used to align the rotors 106, 108 and the stators 102, 104: that is, (i) the rotors 106, 108 may be aligned relative to each other, (ii) the stators 102, 104 may be aligned relative to each other, and/or (iii) the rotors and stators may be aligned to each other (that is, stator-to-rotor alignment). Spacers (not depicted) are added between the rotors 106, 108 and the stators 102, 104. Angular position of the in-line rotors 106, 108 is monitorable by a position encoder 198 that is couplable to the shaft 110 via a toothed belt 199. According to variants, angular position of the in-line rotors 106, 108 is monitorable by measurement of variations in current consumed by: (i) any one of the in-line stators 102, 104, or (ii) the stator 102, and/or (iii) any one of the first stator 102, the second stator 104 and any combination and permutation thereof.

Preferably, the first rotor 106 is cooperative with the first stator 102 while the second rotor 108 is cooperative with the second stator 102. The two in-line stators 102, 104 are coolable by a cooling circuit 134. A plate 133 is used to cover the cooling circuit 134. Bearings 150 are used to rotatably support the shaft 110, and an end plate 152 is used to cover the ends of the drive 100. A junction box 154 is used to house connections for: (i) electrical power used to energize the drive 100, (ii) control signals used to connect the a drive-controller 111 or a drive-controllers 118, 120 and/or (iii) sensor signals used to indicate angular position of the shaft 110. The spline insert 156 is attachable to the shaft 110, and the spline insert 156 may be used to couple or connect the shaft 110 to the molding-system component 112 of FIG. 1.

According to variants, the drive 100 is energizable under the following scenarios: (i) concurrently energizing (at least in part) the first stator 102 and the second stator 104, and/or (ii) de-energizing at least in part the second stator 104 while the first stator 102 remains energized at least in part.

Preferably, during acceleration of the molding-system component 112, the drive 100 is energizable under the following scenarios: (i) energizing at least in part the in-line stators 102, 104, (ii) the first stator 102 is de-energized at least in part, (iii) the first stator 102 is de-energized at least in part while the second stator 104 remains energized at least in part, (iv) the first stator 102 acts to brake, at least in part, acceleration of the molding-system component 112, and/or (v) the first stator 102 acts to regeneratively brake at least in part acceleration of the molding-system component 112 (that is, the first stator 102 acts to generate electrical power as the molding-system component 112 moves so that this condition permits increased braking action to the molding-system component 112).

Preferably, the stator 102 and the corresponding rotor 106 are used as a core or prime provider of motive function of the molding-system component 112, while the stator 104 and the corresponding rotor 108 are followers to complement (or add) power and torque requirements that the core provider cannot provide (for peak-performance situations).

Other technical effects of the drive 100 may be realized depending on the technical features used, such as: (i) during steady state operation of plasticization of a molding material, at least one of the stators 102, 104 which is required for satisfying a transient performance of the molding-system component 112 may be switched off to improve the energy efficiency, (ii) reduction of cost of the drive 100 by usage of multiple (smaller) standard stators and rotors where one stator and one corresponding rotor (capable of providing the same performance) is not a commonly available commercial item (this arrangement would also permit reduction in the lead time of manufacturing through stocking of inventory of standard parts which could be used to selectively assemble to form the drive 100 having the required characteristics for moving the molding-system component 112, (iii) improve energy efficiency of a function of the molding system component 112 by switching off one or more sets of stators and rotors during a lower power consumption of a process of the molding system 10.

According to a variant, the molding-system drive 100 includes at least two in-line stators 102, 104, and the at least two in-line stators 102, 104 may be usable with either: (i) at least two in-line rotors 106, 108 cooperative with the at least two in-line stators 102, 104, or (ii) a rotor 106 (that is, a single rotor) cooperative with the at least two in-line stators 102, 104.

According to another variant, the molding-system drive 100 includes at least two in-line rotors 106, 108, and the at least two in-line rotors 106, 108 may be used with either: (i) at least two in-line stators 102, 104 cooperative with the at least two in-line rotors 106, 108, or a stator 102 (that is, a single stator) cooperative with the at least two in-line rotors 106, 108.

The stators 102, 104 are stationary. The rotors 106, 108 are either movable: (i) rotatably or (ii) linearly translational. The electrical motor 110 may be: (i) a rotating electric motor (in which the rotor is rotatable), and/or (ii) a linear electric motor (in which the rotor is movable linearly).

The description of the exemplary embodiments provides examples of the present invention, and these examples do not limit the scope of the present invention. It is understood that the scope of the present invention is limited by the claims. The concepts described above may be adapted for specific conditions and/or functions, and may be further extended to a variety of other applications that are within the scope of the present invention. Having thus described the exemplary embodiments, it will be apparent that modifications and enhancements are possible without departing from the concepts as described. Therefore, what is to be protected by way of letters patent are limited only by the scope of the following claims:

What is claimed is:

1. A molding-system drive, comprising:
at least two in-line stators.

2. The molding-system drive of claim 1, further comprising:
at least two in-line rotors cooperative with the at least two in-line stators.

3. The molding-system drive of claim 1, further comprising:
a rotor cooperative with the at least two in-line stators.

4. The molding-system drive of claim 2, wherein the at least two in-line rotors are mountable to a common shaft.

5. The molding-system drive of claim 2, wherein the at least two in-line rotors are mountable to a common shaft, and the common shaft is connectable to a molding-system component.

6. The molding-system drive of claim 2, wherein the at least two in-line rotors are mountable to a common shaft, the common shaft is connectable to a molding-system component, the molding-system component includes a processing screw.

7. The molding-system drive of claim 2, wherein the at least two in-line rotors are mountable to a common shaft, the at least two in-line stators and the at least two in-line rotors are energizable to move a molding-system component via the common shaft.

8. The molding-system drive of claim 2, wherein the at least two in-line stators, and the at least two in-line rotors are mountable to a common shaft, the common shaft includes a hollow shaft.

9. The molding-system drive of claim 2, wherein the at least two in-line stators include:
a first stator; and
a second stator offset from the first stator.

10. The molding-system drive of claim 2, wherein the at least two in-line rotors include:
a first rotor; and
a second rotor offset from the first rotor.

11. The molding-system drive of claim 2, wherein the at least two in-line stators and the at least two in-line rotors are operatively couplable to and controllable by a drive-controller.

12. The molding-system drive of claim 2, wherein:
the at least two in-line stators include:
a first stator; and
a second stator offset from the first stator; and
the at least two in-line rotors include:
a first rotor; and
a second rotor offset from the first rotor,
the first stator and the first rotor are operatively couplable to and controllable by a first drive-controller,
the second stator and the second rotor are operatively couplable to and controllable by a second drive-controller.

13. The molding-system drive of claim 2, wherein the at least two in-line rotors are mountable to a common shaft, and angular position of the at least two in-line rotors is monitorable by a position encoder connectable via a belt to a common shaft.

14. The molding-system drive of claim 2, wherein angular position of the at least two in-line rotors is monitorable by measurement of variations in current consumed by the stator.

15. The molding-system drive of claim 2, wherein angular position of the at least two in-line rotors is monitorable by measurement of variations in current consumed by any one of the at least two in-line stators.

16. The molding-system drive of claim 2, wherein:
the at least two in-line stators include:
a first stator; and
a second stator offset from the first stator; and
the at least two in-line rotors include:
a first rotor; and
a second rotor offset from the first rotor,
angular position of any one of the at least two in-line rotors is monitorable by measurement of variations in current consumed by any one of the first stator, the second stator and any combination and permutation thereof.

17. The molding-system drive of claim 2, wherein the at least two in-line stators are mountable to a common housing.

18. The molding-system drive of claim 2, wherein the at least two in-line stators are coolable by a cooling circuit.

19. The molding-system drive of claim 2, wherein:
the at least two in-line stators include:
a first stator; and
a second stator offset from the first stator; and
the at least two in-line rotors include:
a first rotor; and
a second rotor offset from the first rotor, the first rotor is cooperative with the first stator, and the second rotor is cooperative with the second stator.

20. The molding-system drive of claim 19, wherein the first stator, the first rotor, the second stator and the second rotor are concurrently energizable at least in part.

21. The molding-system drive of claim 19, wherein the first stator and the first rotor are de-energizable at least in part while the second stator and the second rotor remain energizable at least in part.

22. The molding-system drive of claim 19, wherein during acceleration of a molding-system component, the at least two in-line stators and the at least two in-line rotors remain energizable at least in part.

23. The molding-system drive of claim 19, wherein during de-acceleration of the molding-system component, the first stator and the first rotor are de-energizable at least in part.

24. The molding-system drive of claim 19, wherein during de-acceleration of the molding-system component, the first stator and the first rotor are de-energizable at least in part while the second stator and the second rotor remain energizable at least in part.

25. The molding-system drive of claim 19, wherein during de-acceleration of the molding-system component, the first stator and the first rotor act to brake at least in part acceleration of the molding-system component.

26. The molding-system drive of claim 19, wherein during de-acceleration of the molding-system component, the first stator and the first rotor act to regeneratively brake at least in part acceleration of the molding-system component.

27. A molding system, comprising:
at least two in-line stators.

28. The molding system of claim 1, further comprising:
at least two in-line rotors cooperative with the at least two in-line stators.

29. The molding system of claim 1, further comprising:
a rotor cooperative with the at least two in-line stators.

30. The molding system of claim 28, wherein the at least two in-line rotors are mountable to a common shaft.

31. The molding system of claim 28, wherein the at least two in-line rotors are mountable to a common shaft, and the common shaft is connectable to a molding-system component.

32. The molding system of claim 28, wherein the at least two in-line rotors are mountable to a common shaft, the common shaft is connectable to a molding-system component, the molding-system component includes a processing screw 114.

33. The molding system of claim 28, wherein the at least two in-line rotors are mountable to a common shaft, the at least two in-line stators and the at least two in-line rotors are energizable to move a molding-system component via the common shaft.

34. The molding system of claim 28, wherein the at least two in-line stators; and the at least two in-line rotors are mountable to a common shaft, the common shaft includes a hollow shaft.

35. The molding system of claim 28, wherein the at least two in-line stators include:
a first stator; and
a second stator offset from the first stator.

36. The molding system of claim 28, wherein the at least two in-line rotors include:
a first rotor; and
a second rotor offset from the first rotor.

37. The molding system of claim 28, wherein the at least two in-line stators and the at least two in-line rotors are operatively couplable to and controllable by a drive-controller.

38. The molding system of claim 28, wherein:
the at least two in-line stators include:
a first stator; and
a second stator offset from the first stator; and
the at least two in-line rotors include:
a first rotor; and
a second rotor offset from the first rotor,
the first stator and the first rotor are operatively couplable to and controllable by a first drive-controller,
the second stator and the second rotor are operatively couplable to and controllable by a second drive-controller.

39. The molding system of claim 28, wherein the at least two in-line rotors are mountable to a common shaft, and angular position of the at least two in-line rotors is monitorable by a position encoder connectable via a belt to a common shaft.

40. The molding system of claim 28, wherein angular position of the at least two in-line rotors is monitorable by measurement of variations in current consumed by the stator.

41. The molding system of claim 28, wherein angular position of the at least two in-line rotors is monitorable by measurement of variations in current consumed by any one of the at least two in-line stators.

42. The molding system of claim 28, wherein:
the at least two in-line stators include:
a first stator; and
a second stator offset from the first stator; and
the at least two in-line rotors include:
a first rotor; and
a second rotor offset from the first rotor,
angular position of any one of the at least two in-line rotors is monitorable by measurement of variations in current consumed by any one of the first stator, the second stator and any combination and permutation thereof.

43. The molding system of claim 28, wherein the at least two in-line stators are mountable to a common housing.

44. The molding system of claim 28, wherein the at least two in-line stators are coolable by a cooling circuit.

45. The molding system of claim 28, wherein:
the at least two in-line stators include:
a first stator; and
a second stator offset from the first stator; and
the at least two in-line rotors include:
a first rotor; and
a second rotor offset from the first rotor, the first rotor is cooperative with the first stator, and the second rotor is cooperative with the second stator.

46. The molding system of claim 45, wherein the first stator, the first rotor, the second stator and the second rotor are concurrently energizable at least in part.

47. The molding system of claim 45, wherein the first stator and the first rotor are de-energizable at least in part while the second stator and the second rotor remain energizable at least in part.

48. The molding system of claim 45, wherein during acceleration of a molding-system component, the at least two in-line stators and the at least two in-line rotors remain energizable at least in part.

49. The molding system of claim 45, wherein during de-acceleration of the molding-system component, the first stator and the first rotor are de-energizable at least in part.

50. The molding system of claim 45, wherein during de-acceleration of the molding-system component, the first stator and the first rotor are de-energizable at least in part while the second stator and the second rotor remain energizable at least in part.

51. The molding system of claim 45, wherein during de-acceleration of the molding-system component, the first stator and the first rotor act to brake at least in part acceleration of the molding-system component.

52. The molding system of claim 45, wherein during de-acceleration of the molding-system component, the first stator and the first rotor act to regeneratively brake at least in part acceleration of the molding-system component.

53. A method, comprising:
placing at least two stators of a molding-system drive in-line with each other; and
placing at least two rotors of the molding-system drive in-line with each other, the at least two rotors cooperative with the at least two stators.

54. The method of claim 53, further comprising:
placing the at least two in-line rotors on a common shaft.

55. The method of claim 53,
placing the at least two in-line rotors on a common shaft; and
connecting the common shaft to a molding-system component.

56. A molding-system drive, comprising:
at least two in-line rotors.

57. The molding-system drive of claim 56, further comprising:
at least two in-line stators cooperative with the at least two in-line rotors.

58. The molding-system drive of claim 56, further comprising:
a stator cooperative with the at least two in-line rotors.

59. The molding-system drive of claim 57, wherein the at least two in-line rotors are mountable to a common shaft.

60. The molding-system drive of claim 57, wherein the at least two in-line rotors are mountable to a common shaft, and the common shaft is connectable to a molding-system component.

61. The molding-system drive of claim 57, wherein the at least two in-line rotors are mountable to a common shaft, the common shaft is connectable to a molding-system component, the molding-system component includes a processing screw 114.

62. The molding-system drive of claim 57, wherein the at least two in-line rotors are mountable to a common shaft, the at least two in-line stators and the at least two in-line rotors are energizable to move a molding-system component via the common shaft.

63. The molding-system drive of claim 57, wherein the at least two in-line stators, and the at least two in-line rotors are mountable to a common shaft, the common shaft includes a hollow shaft.

64. The molding-system drive of claim 57, wherein the at least two in-line stators include:
a first stator; and
a second stator offset from the first stator.

65. The molding-system drive of claim 57, wherein the at least two in-line rotors include:
a first rotor; and
a second rotor offset from the first rotor.

66. The molding-system drive of claim 57, wherein the at least two in-line stators and the at least two in-line rotors are operatively couplable to and controllable by a drive-controller.

67. The molding-system drive of claim 57, wherein:
the at least two in-line stators include:
a first stator; and
a second stator offset from the first stator; and
the at least two in-line rotors include:
a first rotor; and
a second rotor offset from the first rotor,
the first stator and the first rotor are operatively couplable to and controllable by a first drive-controller,
the second stator and the second rotor are operatively couplable to and controllable by a second drive-controller.

68. The molding-system drive of claim 57, wherein the at least two in-line rotors are mountable to a common shaft, and angular position of the at least two in-line rotors is monitorable by a position encoder connectable via a belt to a common shaft.

69. The molding-system drive of claim 57, wherein angular position of the at least two in-line rotors is monitorable by measurement of variations in current consumed by the stator.

70. The molding-system drive of claim 57, wherein angular position of the at least two in-line rotors is monitorable by measurement of variations in current consumed by any one of the at least two in-line stators.

71. The molding-system drive of claim 57, wherein:
the at least two in-line stators include:
a first stator; and
a second stator offset from the first stator; and
the at least two in-line rotors include:
a first rotor; and
a second rotor offset from the first rotor,
angular position of any one of the at least two in-line rotors is monitorable by measurement of variations in current consumed by any one of the first stator, the second stator and any combination and permutation thereof.

72. The molding-system drive of claim 57, wherein the at least two in-line stators are mountable to a common housing.

73. The molding-system drive of claim 57, wherein the at least two in-line stators are coolable by a cooling circuit.

74. The molding-system drive of claim 57, wherein:
the at least two in-line stators include:
a first stator; and
a second stator offset from the first stator; and
the at least two in-line rotors include:
a first rotor; and
a second rotor offset from the first rotor, the first rotor is cooperative with the first stator, and the second rotor is cooperative with the second stator.

75. The molding-system drive of claim 74, wherein the first stator, the first rotor, the second stator and the second rotor are concurrently energizable at least in part.

76. The molding-system drive of claim 74, wherein the first stator and the first rotor are de-energizable at least in part while the second stator and the second rotor remain energizable at least in part.

77. The molding-system drive of claim 74, wherein during acceleration of a molding-system component, the at least two in-line stators and the at least two in-line rotors remain energizable at least in part.

78. The molding-system drive of claim 74, wherein during de-acceleration of the molding-system component, the first stator and the first rotor are de-energizable at least in part.

79. The molding-system drive of claim 74, wherein during de-acceleration of the molding-system component, the first stator and the first rotor are de-energizable at least in part while the second stator and the second rotor remain energizable at least in part.

80. The molding-system drive of claim 74, wherein during de-acceleration of the molding-system component, the first stator and the first rotor act to brake at least in part acceleration of the molding-system component.

81. The molding-system drive of claim 74, wherein during de-acceleration of the molding-system component, the first stator and the first rotor act to regeneratively brake at least in part acceleration of the molding-system component.

82. A molding system, comprising:
at least two in-line stators.

83. The molding system of claim 82, further comprising:
at least two in-line rotors cooperative with the at least two in-line stators.

84. The molding system of claim 82, further comprising:
a rotor cooperative with the at least two in-line stators.

85. The molding system of claim 83, wherein the at least two in-line rotors are mountable to a common shaft.

86. The molding system of claim 83, wherein the at least two in-line rotors are mountable to a common shaft, and the common shaft is connectable to a molding-system component.

87. The molding system of claim 83, wherein the at least two in-line rotors are mountable to a common shaft, the common shaft is connectable to a molding-system component, the molding-system component includes a processing screw 114.

88. The molding system of claim 83, wherein the at least two in-line rotors are mountable to a common shaft, the at least two in-line stators and the at least two in-line rotors are energizable to move a molding-system component via the common shaft.

89. The molding system of claim 83, wherein the at least two in-line stators; and the at least two in-line rotors are mountable to a common shaft, the common shaft includes a hollow shaft.

90. The molding system of claim 83, wherein the at least two in-line stators include:
a first stator; and
a second stator offset from the first stator.

91. The molding system of claim 83, wherein the at least two in-line rotors include:
a first rotor; and
a second rotor offset from the first rotor.

92. The molding system of claim 83, wherein the at least two in-line stators and the at least two in-line rotors are operatively couplable to and controllable by a drive-controller.

93. The molding system of claim 83, wherein:
the at least two in-line stators include:
a first stator; and
a second stator offset from the first stator; and
the at least two in-line rotors include:
a first rotor; and
a second rotor offset from the first rotor,
the first stator and the first rotor are operatively couplable to and controllable by a first drive-controller,
the second stator and the second rotor are operatively couplable to and controllable by a second drive-controller.

94. The molding system of claim 83, wherein the at least two in-line rotors are mountable to a common shaft, and angular position of the at least two in-line rotors is monitorable by a position encoder connectable via a belt to a common shaft.

95. The molding system of claim 83, wherein angular position of the at least two in-line rotors is monitorable by measurement of variations in current consumed by the stator.

96. The molding system of claim 83, wherein angular position of the at least two in-line rotors is monitorable by measurement of variations in current consumed by any one of the at least two in-line stators.

97. The molding system of claim 83, wherein:
the at least two in-line stators include:
a first stator; and
a second stator offset from the first stator; and
the at least two in-line rotors include:
a first rotor; and
a second rotor offset from the first rotor,
angular position of any one of the at least two in-line rotors is monitorable by measurement of variations in current consumed by any one of the first stator, the second stator and any combination and permutation thereof.

98. The molding system of claim 83, wherein the at least two in-line stators are mountable to a common housing.

99. The molding system of claim 83, wherein the at least two in-line stators are coolable by a cooling circuit.

100. The molding system of claim 83, wherein:
the at least two in-line stators include:
a first stator; and
a second stator offset from the first stator; and
the at least two in-line rotors include:
a first rotor; and
a second rotor offset from the first rotor, the first rotor is cooperative with the first stator, and the second rotor is cooperative with the second stator.

101. The molding system of claim 100, wherein the first stator, the first rotor, the second stator and the second rotor are concurrently energizable at least in part.

102. The molding system of claim 100, wherein the first stator and the first rotor are de-energizable at least in part while the second stator and the second rotor remain energizable at least in part.

103. The molding system of claim 100, wherein during acceleration of a molding-system component, the at least two in-line stators and the at least two in-line rotors remain energizable at least in part.

104. The molding system of claim 100, wherein during de-acceleration of the molding-system component, the first stator and the first rotor are de-energizable at least in part.

105. The molding system of claim 100, wherein during de-acceleration of the molding-system component, the first stator and the first rotor are de-energizable at least in part while the second stator and the second rotor remain energizable at least in part.

106. The molding system of claim 100, wherein during de-acceleration of the molding-system component, the first stator and the first rotor act to brake at least in part acceleration of the molding-system component.

107. The molding system of claim 100, wherein during de-acceleration of the molding-system component, the first stator and the first rotor act to regeneratively brake at least in part acceleration of the molding-system component.
